(19) United States
(12) Patent Application Publication
(10) Pub. No.: US 2005/0090170 A1
(43) Pub. Date: Apr. 28, 2005

(54) Breathable laminate

(76) Inventor: Dan L. Jackson, Starkville, MS (US)

Correspondence Address: David C. Burleson;OMNOVA Solutions, Inc., 175 Ghent Road, Fairlawn, OH, 44333-3300, US

(21) Appl. No.: 10/970,626

(22) Filed: Oct. 21, 2004

Related U.S. Application Data
(60) Provisional application No. 60/514,181, filed on Oct. 24, 2003.

(51) Int. Cl. D03D 15/00; B32B 3/00; D03D 25/00; B32B 5/26; B32B 27/14; B32B 5/28; B32B 5/08; B32B 5/18

(52) U.S. Cl. 442/218; 442/225; 442/381; 442/226

(57) ABSTRACT

A wallcovering that has a moisture permeability of at least about 25 perms is provided by bonding first and second porous fabric sheets by an adhesively effective amount of a fused plastisol. Methods of making the breathable wallcovering and methods of using the breathable wallcovering are also provided.

### PRIORITY CLAIM

The Non-provisional Patent Application claims priority from U.S. Provisional Patent Application having Ser. No. 60/514,181, filed on Oct. 24, 2003, and titled BREATHABLE LAMINATE, wherein said provisional application is commonly owned by the assignee of the present application and wherein the entire contents of said provisional application is incorporated herein by reference.

### BACKGROUND INFORMATION

The invention relates to breathable laminates, more specifically to breathable wallcoverings that permit moisture vapor to freely pass therethrough to reduce trapping of moisture between the wallcovering and a supporting substrate.

The general moisture impermeability of sheets made from poly(vinyl chloride) (hereinafter “PVC or vinyl”) is well known. In fact, this feature is used widely to advantage by architects, environmental engineers, builders, and the like in such applications as geomembranes (e.g., pond liners), roofing membranes, shower pan liners, etc., where the prevention of moisture moving into or away from an area is undesirable.

Because of their printability and durability, PVC sheets also have been used as decorative coverings, particularly as decorative laminates and wallcoverings, i.e., wallpapers and commercial wallcoverings (i.e., fabric-backed wallpapers). These decorative materials generally have the same moisture impermeability characteristics as the aforementioned membranes put to more industrial-type usages. While moisture impermeability can be desirable in many wallcovering applications, such as in bathrooms and kitchens, moisture impermeable wallcoverings may be less desirable under other circumstances.

A building that is poorly constructed (e.g., one with exterior leaks, improperly designed air conditioning vents and returns, etc.) and/or has negative air flow conditions can have significant moisture condensation. In situations where wallcoverings are used, this often occurs behind the wallcovering. The low moisture permeability of PVC sheets, which is well known as described above, inhibits the transport of moisture and condensate into the room at a rate equal to that at which moisture permeates through the building walls, thereby causing accumulation of moisture behind the wallcovering.

Water that is trapped between a wallcovering and a wall may assist growth of molds and mildew in the wallcovering paste. Many commonly used pastes contains organic materials, such as starch and byproducts thereof, that can serve as nutrients for sustaining the growth of molds and mildew. Such growth commonly is accompanied by staining or discoloration of the wallcovering and by the presence of offensive odors.

The breathability or moisture permeability of wallcoverings is most frequently and appropriately expressed quantitatively in units of “perms,” which is a term used in the industry corresponding to grams of moisture (water) permeating a sample (e.g., a wallcovering) per square meter per hour under specified conditions. Conventional vinyl wallcoverings generally have a moisture permeability of about 1 or 2 perms. Moisture permeability commonly is evaluated by a test such as, e.g.. ASTM Standard Test Method E96.

U.S. Pat. No. 5,262,444 to Rusincovitch et al. discloses a breathable, plastic film, useful as a wallcovering material, which is prepared by combining a plastisol with a low boiling point additive, extruding the plastisol mixture containing the low boiling point additive to form a film, and curing the film under conditions whereby the additive volatilizes through the cured film to form a multiplicity of holes in the film. The reference reports perm values generally ranging from about 1.0 to about 20.0. While the Rusincovitch et al. patent generally reports perm values which are considerably higher than those of conventional vinyl wallcoverings, still higher moisture permeabilities would be advantageous and desirable.

A breathable, decorative wallcovering having a smooth, continuous, aesthetically appealing exposed surface is disclosed in U.S. Pat. No. 6,238,789 to Jackson. The wallcovering is described as being printable with a design or pattern having sharply defined edges, and having a relatively high moisture permeability. The structure includes a porous polymeric ply fused to and supported by a nonwoven substrate ply which consists of an array of hydroentangled fibers. The porous polymeric ply is formed by thermally fusing a plastisol coating, which is applied to the nonwoven substrate ply, and which has a thickness sufficiently low to permit localized variations in fiber orientation and small variations in the thickness of the nonwoven substrate ply to cause the formation of a multiplicity of miniature discontinuities which are substantially invisible to the unaided eye and which are randomly distributed throughout the coating. The plastisol coating is, however, thick enough to allow the formation of a coating which upon thermal fusion provides a polymeric ply having a smooth continuous appearance. The wallcovering is particularly useful where a smooth surface is desired for aesthetic reasons and where high moisture permeability is also desired.

U.S. Pat. No. 5,681,408 to Pate, et al. discloses a three-layer moisture-permeable acoustic lamina which is usable as a wall covering. The top layer of a foraminous woven fabric layer is adhered to a bottom fabric backing by a discontinuous intermediate thermoplastic polymer layer. The woven fabric preferably has an embossed undulate outer surface to enhance the acoustic properties of the lamina and to impart an aesthetic textural appearance. The individual yams of the woven fabric are preferably substantially uniformly coated with a PVC plastisol to impart stain and wear-resistance, inhibit the growth of molds, fungi, bacteria and the like, and to enhance the appearance of the exposed face of the lamina. The moisture-permeable lamina structure allows wallcovering paste, used to adhere the lamina to a wall, to dry at an acceptable rate yet does not allow paste to bleed through the foraminous woven fabric layer.

### SUMMARY OF THE INVENTION

A breathable wallcovering is provided that comprises a first porous fabric sheet bonded to a second porous fabric by an adhesively effective amount of a fused plastisol. The wallcovering has a moisture permeability of at least about 25 perms. More specifically, the first porous fabric has a first major surface and a second major surface and the second porous fabric sheet has a first major surface and a second major surface. The first major surface of the first porous fabric sheet is bonded to the first major surface of the second porous fabric sheet by the plastisol.

Because of the unique configuration of the present wallcovering, little or no plastisol material penetrates to the second major surface of the second fabric sheet. This surface is therefore readily adhered to a substrate without interference from the plastisol composition, and also provides a surface conducive to enhancing stripability of the wallcovering from the substrate. Additionally, the wallcovering of the present invention, by virtue of the selection of components, presents an excellent surface for printability. Depending on the amount and location of coating of the plastisol, either a fabric surface or plastisol surface is presented as the outermost layer of the wallcovering, either of which may be highly receptive to printing.

Because the present wallcovering is a combination of fabric materials, moisture permeability far exceeds the permeability of presently available perforated vinyl film products. While not being bound by theory, it is believed that the fabric product of the present invention exhibits little or no masking of the substrate that would tend to trap moisture below the surface of the wallcovering.

Most preferably, the wallcovering of the present invention exhibits moisture transfer properties that actually enhance the perm value of the substrate to which it is attached. While not being bound by theory, it is believed that the wallcovering of the present invention presents a very high surface area that may enhance the moisture transfer properties of the substrate as compared to a like substrate without the present invention.

### BRIEF DESCRIPTION OF THE DRAWING

The accompanying drawings, which are incorporated in and constitute a part of this application, illustrate several aspects of the invention and together with a description of the embodiments serve to explain the principles of the invention. A brief description of the drawings is as follows:

FIG. 1 is an expanded view of a breathable wallcovering of the present invention;

FIG. 2 is an expanded view of another embodiment of a breathable wallcovering of the present invention;

FIG. 3 is an expanded view of another embodiment of a breathable wallcovering of the present invention;

FIG. 4 is a non-limiting exemplary schematic of a process for carrying out the present invention;

FIG. 5 is a non-limiting exemplary schematic of an alternative process for carrying out the present invention; and

FIG. 6 is a non-limiting exemplary schematic of an alternative process for carrying out the present invention.

### DETAILED DESCRIPTION OF ILLUSTRATIVE EMBODIMENTS

Breathable, as used herein, refers to the ability of the wallcovering to allow moisture vapor to be transmitted therethrough. That is, “breathability,” as used herein, is substantially synonymous with moisture permeability.

“Porous” and “discontinuous,” as used herein, generally refers to the existence of a multitude of small holes, openings or gaps in the wallcovering which are responsible for the breathability or high moisture permeability of the wallcovering.

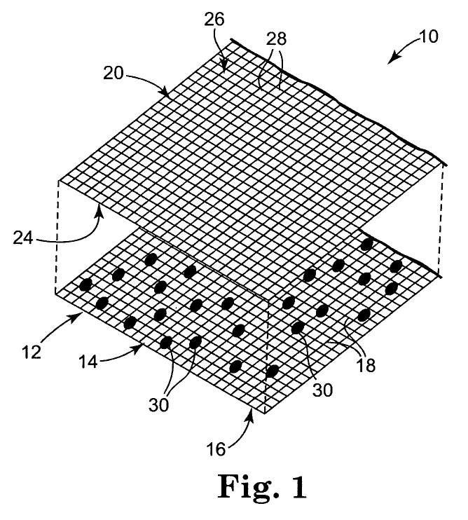

Turning now to the drawings, wherein like numbers represent like parts, FIG. 1 is an expanded view of a breathable wallcovering 10 of the present invention. A first porous fabric sheet 12 is provided having a first major surface 14 and a second major surface 16. As shown, first porous fabric sheet 12 is a woven fabric comprising fibers 18 woven in a warp and weft fashion to form a web.

A second porous fabric sheet 20 is provided having a first major surface 24 and a second major surface 26. As shown, second porous fabric sheet 20 is a woven fabric comprising fibers 28 also woven in a warp and weft fashion to form a web.

The fabrics selected for use as first porous fabric sheet 12 and second porous fabric sheet 20 may be a woven web, such as drill, scrim, cheese-cloth, and so forth, or a knit fabric. Preferably, the woven fabric has a thread count of 30×20 to about 40×40, more preferably from about 32×22 to about 36×36, and is made of fibers of about 200 to about 400 denier. Preferably, the thread count of one of the porous fabric sheets is somewhat higher than the thread count of the other porous fabric sheet, in order to avoid creation of a moiré effect. Most preferably, the thread count of the fabric sheet intended to be on the outside of the wallcovering (i.e. not adhered to the surface to be covered by the wallcovering) has the higher thread count of the first and second fabric sheets. This orientation of the fabric sheets provides an aesthetic benefit, and additionally may provide for more advantageous stripability of the wallcovering from the surface to which it is adhered.

Suitable thicknesses for the fabric can vary. However, thicknesses ranging from about 4 to about 40 mils (from about 0.1 mm to about 1.0 mm) are generally desirable, with thicknesses from between about 8 mils (0.2 mm) to about 25 mils (0.6 mm) being preferred. Fabric weight for the fabric can also vary considerably. However, fabric weights from about 1.9 ounces per square yard (47 grams per square meter) to about 2.5 ounces per square yard (61 grams per square meter) are generally preferred.

Either of the fabrics of the wallcovering as described herein can be made of cellulosic fiber (such as cotton or wool); synthetic fibers, such as nylon, polyester, aramid, polyolefin, rayon or acrylic fibers; or mineral fibers (such as glass); or cords or combinations of the same. In one embodiment, blends of cellulosic and synthetic fibers are preferred. Specifically, it is preferred that the fabric be prepared or consist of a blend containing at least about 10 percent by weight of at least one synthetic polymeric fiber to provide the fabric with better strength properties such as improved tear resistance. It is also desirable that the total fiber content of the fabric be comprised of at least about 20-35 percent by weight of cellulosic fibers to provide improved absorption and adhesion character (i.e., the ability to adhere the wallcovering to a wall or other substrate using a conventional wallcovering adhesive). Particularly preferred are blends of polyester fiber and cellulosic fiber comprising from about 65 to about 80 percent by weight of polyester fibers, and from about 20 to about 35 percent by weight of cellulosic fibers. In another embodiment, preferably one of the fabrics is made from cellulosic fibers and the other fabric is made from synthetic fibers. Most preferably, the fabric sheet intended to be on the outside of the wallcovering (i.e. not adhered to the surface to be covered by the wallcovering) is made from synthetic fibers and the fabric intended to be on the inside of the wallcovering (i.e. adhered to the surface to be covered by the wallcovering) is made from cellulosic fibers.

Plastisol regions 30 bond first porous fabric sheet 12 to second porous fabric sheet 20. As shown, plastisol regions 30 are represented as discontinuous regions similar to droplets dispersed on the first major surface 14 of first porous fabric sheet 12. As noted above, FIG. 1 is an expanded view, and so when the first major surface 14 of first porous fabric sheet 12 is in contact with the first major surface 24 of second porous fabric sheet 20, plastisol regions 30 act as connective material to bond first porous fabric sheet 12 to second porous fabric sheet 20. In the embodiment as shown, plastisol regions 30 are completely discontinuous, i.e. are unconnected and do not form a continuous layer between first porous fabric sheet 12 and second porous fabric sheet 20. In this embodiment, plastisol is provided in an amount sufficient to provide bonding points between first porous fabric sheet 12 and second porous fabric sheet 20 in an amount effective to adhere the fabric sheets to one another. Preferably, plastisol is provided at a coating weight of from about 0.33 lbs/yd² to about 0.66 lbs/yd².

In an alternative embodiment, plastisol regions 30 may be connected in a lattice-like formation to form a permeable matrix. In this embodiment, a plastisol coating is provided in an amount sufficiently low to permit localized variations in fiber orientation and small variations in the thickness of the nonwoven substrate ply to cause highly localized flow which results in the formation of a multiplicity of discontinuities.

The plastisol coating is fused to bond first porous fabric sheet 12 to second porous fabric sheet 20 by heating the coating to a temperature in excess of the fusion temperature of the polymeric resin or resins contained in the plastisol.

Suitable plastisols for use with the invention generally include well known plastisol compositions consisting primarily of a dispersion of finely divided resin in a plasticizer. Suitable resins generally include a variety of thermoplastic resins which are capable of fusing and absorbing the plasticizer upon application of heat. Examples of thermoplastic resins which can be used include polyacrylates, polyvinyl acetate, polyamides, various acrylic copolymers, polyvinyl chloride and the like. For purposes of this specification, the term plastisol is meant to also embrace organosols, which are a dispersion of a thermoplastic resin in a mixture of plasticizer and a carrier solvent. Plastisol compositions which can be used with the invention generally include from about 20 to about 200 parts of plasticizer, desirably from about 50 to about 80 parts of plasticizer and more preferably from about 60 to 70 parts of plasticizer, per 100 parts by weight of resin. Particularly preferred are polyvinyl chloride plastisols.

Suitable plasticizers for use in plastisol compositions are generally well known to the art and literature. Examples of plasticizers which can be used generally include nonvolatile organic liquids, and low melting organic solids. Examples of plasticizers which can be used include tallates, adipates, trimellitates, sebacate esters, epoxidized soybean oil, acetates, azelates, glutamates, aliphatic esters and aryl phosphates and aromatic or alkyl aromatic esters and mixtures thereof. Specific examples include butyl octyl phthalate, dioctyl phthalate, hexyl decyl phthalate, dihexyl phthalate, diiooctyl phthalate, dicapryl phthalate, di-n-hexyl azelate, diisononyl phthalate, dioctyl adipate, tricresyl phosphate, cresyl diphenyl phosphate, polymeric plasticizers, such as adipic acid polyester, azelaic acid polyester and sebacic acid polyester, isooctyl epoxy tallate, and mixtures thereof.

Examples of other conventional components which can be incorporated into the plastisol composition include various silicas such as precipitated silica, fumed colloidal silica, calcium silicate and the like, ultraviolet light absorbers, fungicides, barium-cadmium-zinc stabilizers, barium-cadmium stabilizers, zinc stabilizers, dibasic lead phosphite, antimony oxide, and pigments such as titanium oxide, red iron oxide, phthalocyanine blue or green, and the like. Preferred stabilizers are cadmium free or cadmium and barium free stabilizers. The pigments and other additives or compounding ingredients are used in effective amounts to control color, mildew, stabilization, etc. of the plastisol.

The porosity of the fabrics and the amount of plastisol used to fuse the first and second fabrics together are selected so that the wallcovering has a moisture permeability of at least about 25 perms as measured by ASTM E96, water method. Preferably the wallcovering of the present invention has a moisture permeability of at least about 40 perms, and more preferably at least about 60 perms.

The breathable wallcovering of the invention can generally be printed with any desired design or pattern using conventional printing techniques. In the embodiment of the present invention wherein sufficient amount of plastisol is apparent on the second major surface 16 of the first porous fabric coating as to provide a macroscopically continuous, smooth appearance, the plastisol can be embossed to provide an aesthetic texture as desired using conventional embossing or texturing techniques. Similarly, when the plastisol presents a macroscopically continuous, smooth appearance, the outer or exposed surface of the wallcovering composite of the present invention can particularly be provided with a printed decorative design or pattern having relatively smooth, sharply defined edges having an aesthetic appeal which is comparable to conventional smooth wallcoverings having a low moisture permeability.

On account of its relatively high permeability, the wallcovering of the invention aids in controlling or diminishing moisture collection between the wallcovering and the wall to which it is applied.

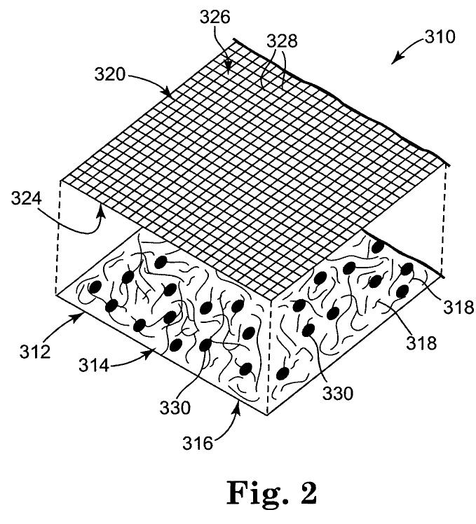

FIG. 2 is an expanded view of an alternative breathable wallcovering 310 of the present invention. A first porous fabric sheet 312 is provided having a first major surface 314 and a second major surface 316. As shown, first porous fabric sheet 312 is a nonwoven fabric comprising randomly oriented fibers 318 forming a web. A second porous fabric sheet 320 is provided having a first major surface 324 and a second major surface 326. As shown, second porous fabric sheet 320 is a woven fabric comprising fibers 328 woven in a warp and weft fashion to form a web. In an alternative embodiment, the second porous fabric sheet 320 may be a nonwoven fabric as described above. In yet another embodiment, the first porous fabric sheet 312 may be a woven fabric as described above, and the second porous fabric sheet 320 may be a nonwoven fabric.

When first porous fabric sheet 312 (or second porous fabric sheet 320) is a nonwoven web, the fabric is comprised of an array of synthetic polymeric fibers and/or and cellulosic fibers which are physically entangled or mechanically interlocked. The nonwoven fabric to be used in the present invention has a relatively open and porous or reticular structure that allows for the free passage of air and moisture, such that the moisture permeability of the wallcovering of the present invention is generally controlled by the rate at which moisture is able to permeate the porous polymeric ply. The nonwoven fabric sheet 312 advantageously provides a different orientation of fibers from second porous fabric sheet 320, thereby avoiding undesired alignment or moiré issues. Additionally, the random orientation of the fibers may provide a more aesthetically pleasing appearance relative to woven fabrics.

The nonwoven fabrics which are suitable for use with the invention preferably are nonwoven cloths made standard web forming processes, such as wet laying processes, dry laying processes (including air laying with optional carding steps) and direct laid processes (including spun-bond, melt-blown and film fibrillation processes). Nonwoven fabrics may additionally be prepared by hydroentanglement processes, wherein a web of fibers is treated with jets of high pressure water or other liquid that serves to entangle the fibers. The water or liquid jets force the fibers into orientations where the fibers individually are at various angles with respect to each other and become physically entangled. Methods of preparing hydroentangled nonwoven fabrics are described, for example, in U.S. Pat. No. 3,537,945.

Preferably, the nonwoven fabric comprises gaps between fibers of the fabric of an average size that is equivalent to that of a woven fabric having a thread count of 30×20 made from 300 denier fibers. More preferably, the gaps have of an average size that is equivalent to that of a woven fabric having a thread count of 36×36 made from 300 denier. Fabric thicknesses and fiber selection preferably are the same as discussed above in the context of woven fabrics.

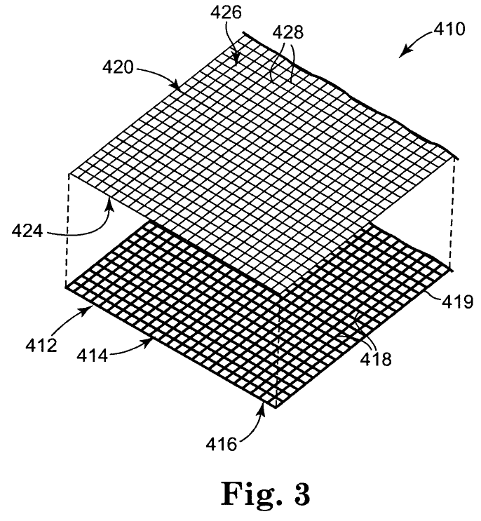

FIG. 3 is an expanded view of a breathable wallcovering 410 of the present invention. A first porous fabric sheet 412 is provided having a first major surface 414 and a second major surface 416. As shown, first porous fabric sheet 412 is a woven fabric comprising fibers 418 woven in a warp and weft fashion to form a web. Plastisol 419 is applied to fibers 418 in an amount sufficient to at least partially coat fibers 418, but in a low enough amount to retain pores or gaps in porous fabric sheet 412. As shown, plastisol 419 is applied in an amount to completely coat fibers 418.

A second porous fabric sheet 420 is provided having a first major surface 424 and a second major surface 426. As shown, second porous fabric sheet 420 is a woven fabric comprising fibers 428 also woven in a warp and weft fashion to form a web. FIG. 3 is an expanded view, and so when the first major surface 414 of first porous fabric sheet 412 is in contact with the first major surface 424 of second porous fabric sheet 420, plastisol 419 acts as connective material to bond first porous fabric sheet 412 to second porous fabric sheet 420. Second major surface 416 of first porous fabric sheet 412 thus presents at least partially plastisol-coated fibers, and preferably completely coated fibers, that are readily printable using conventional printing inks. In one aspect of the present invention, the discontinuities as viewed from the second major surface 416 side of the wallcovering may be miniature or microscopic is size so as to be substantially invisible to the unaided eye and which are randomly distributed throughout the coating. In this aspect, sufficient amount of plastisol is apparent on the second major surface 416 of the first porous fabric coating as to provide a macroscopically continuous, smooth appearance onto which a sharply defined pattern or design can be printed.

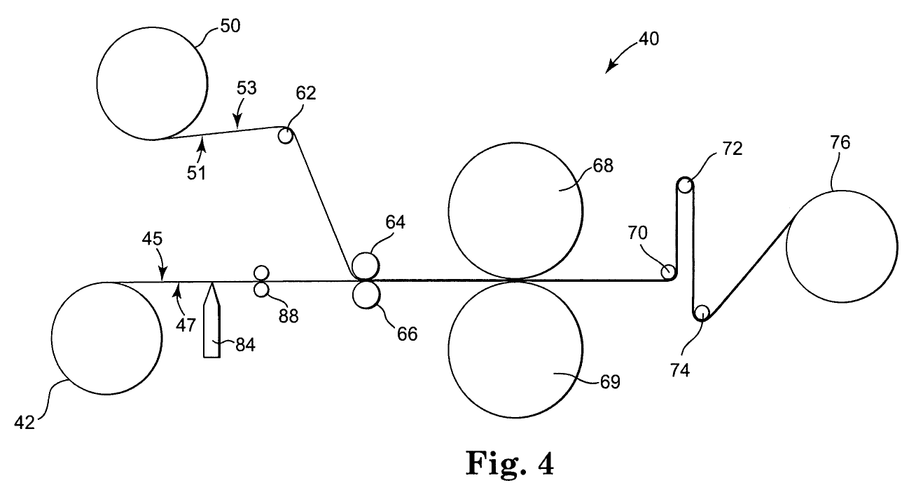

FIG. 4 shows an exemplary schematic of a process for carrying out the present invention. In process 40 as shown, first porous fabric 42 is provided having first major surface 45 and second major surface 47. A second porous fabric 50 is provided, having first major surface 51 and second major surface 53, which will be laminated to first porous fabric 42 as described herein.

Plastisol is preferably applied to first porous fabric 42 in an amount sufficient to bond first porous fabric 42 to second porous fabric 50. In a preferred embodiment as shown, plastisol is applied to the second major surface 47 at plastisol delivery station 84. It has surprisingly been found that, by selection of an appropriately porous fabric 42 and plastisol at the appropriate viscosity at the time of application and processing, plastisol can be applied to the opposite side of first porous fabric 42 from the side that will be in contact with second porous fabric 50, with sufficient plastisol passing through first porous fabric 42 to bond first porous fabric 42 to second porous fabric 50. The application of plastisol to the second major surface 47 of first porous fabric 42 is advantageous, because it assures that plastisol is present on the second major surface 47, providing an aesthetic benefit and optionally an excellent surface that is highly receptive to printing and/or imaging.

Plastisol may be applied in any appropriate manner, as will now be apparent to those of skill in the art, either as a thin coating that is subsequently rendered highly permeable or as a discontinuous application of material. Examples of techniques which might be suitable for applying the plastisol composition to the first porous fabric 42 include knife coating, reverse roll coating, pad coating, padded gravure coating, and rotary screen coating. A particularly preferred method of applying the plastisol composition to the first major surface of the first porous fabric sheet is by a padded gravure coating process. In one aspect, the plastisol may be applied very thinly to the first porous fabric 42 such that highly localized flow of the plastisol composition due to localized variations in fiber orientation and thickness or unevenness of the surface of the fabric results in small discontinuities, holes or gaps, which upon fusion form miniature holes or pores in the fused polymeric ply. The plastisol coating is preferably applied to a thickness of from about 2 mils (0.05 mm) to about 4 mils (0.10 mm), and at a coating weight of from about 1.5 ounces per square yard (47 grams per square meter) to about 5.0 ounces per square yard (155 grams per square meter). The plastisol composition is preferably applied to the nonwoven substrate ply at a viscosity of from about 1500 centipoise to about 8000 centipoise at the temperature at which it is applied to the substrate ply.

Optionally, an operation subsequent to application of the plastisol to the first major surface 45 of first porous fabric 42 may be carried out at plastisol modulation station 88 to remove excess amounts of plastisol, or to redistribute plastisol on first major surface 45. Removal of excess plastisol material may be carried out by techniques that will now be apparent, such as by doctor blade, pressure nip rollers, and the like. Optionally, other techniques may be used to assure that the plastisol as applied to the fabric does not form a continuous layer or does not fill in all gaps in the fabrics. Such techniques may include, for example, use of a pressurized air knife or air bar to assure proper plastisol amounts and distribution in the present wallcoverings. Similarly, redistribution of plastisol on major surface 45 may be carried out by roll nips, gravure rolls, doctor blades, or other such mechanisms.

As noted above, a second porous fabric 50 is provided having first major surface 51 and second major surface 53. This fabric is guided by guides 62 (such as rollers or slide bars) as desired to position to be contacted with first porous fabric 42 at nip rollers 64 and 66. After first major surface 45 of first porous fabric 42 is associated with first major surface 51 of second porous fabric 50, the combined fabrics are passed through curing drums 68 and 69, which are heated rollers that apply heat and pressure to the first porous fabric 42 and second porous fabric 50, thereby fusing the plastisol to both fabric sheets. Alternative mechanisms for laminating first porous fabric 42 to second porous fabric 50 may be utilized, as will be appreciated in combination with the present teaching by those skilled in the art. The fused laminate is then guided by such guide rollers or slide bars 70, 72 and 74 as desired to direct the laminate to take-up roll 76.

Subsequent printing and cutting operations may be carried out on a finished roll as provided in the above described lamination process, or may alternatively be carried out in line with the present lamination process without an intermediate wind-up roll step.

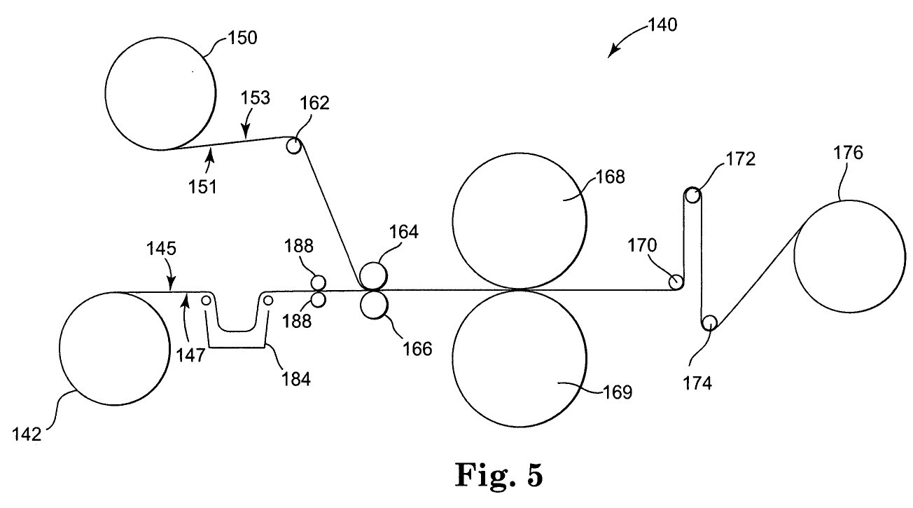

FIG. 5 is an alternative exemplary schematic of a process for carrying out the present invention. In process 140 as shown, first porous fabric 142 is provided having first major surface 145 and second major surface 147. In this process 140, plastisol is applied to both the first major surface 145 and the second major surface 147 at plastisol delivery station 184. As shown, first porous fabric 142 is immersed into a plastisol bath. Alternatively, plastisol may be applied to both major surfaces of first porous fabric sheet 142 by separate application processes to first major surface 145 and second major surface 147 in any appropriate technique such as described above.

Optionally, an operation subsequent to application of the plastisol to first porous fabric 142 may be carried out at plastisol modulation station 188 to remove excess amounts of plastisol, or to redistribute plastisol on first major surface 145 and second major surface 147. Such operations may be carried out as described above.

A second porous fabric 150 is provided, having first major surface 151 and second major surface 153. This fabric is guided by guides 162 (such as rollers or slide bars) as desired to position to be contacted with first porous fabric 142 at nip rollers 164 and 166. After first major surface 145 of first porous fabric 1 is associated with first major surface 151 of second porous fabric 150, the combined fabrics are passed through curing drums 168 and 169, which are heated rollers that apply heat and pressure to the first porous fabric 142 and second porous fabric 150, thereby fusing the plastisol to both fabric sheets. Alternative mechanisms for laminating first porous fabric 142 to second porous fabric 150 may be utilized, as will be appreciated in combination with the present teaching by those skilled in the art. The fused laminate is then guided by such guide rollers or slide bars 170, 172 and 174 as desired to direct the laminate to take-up roll 176.

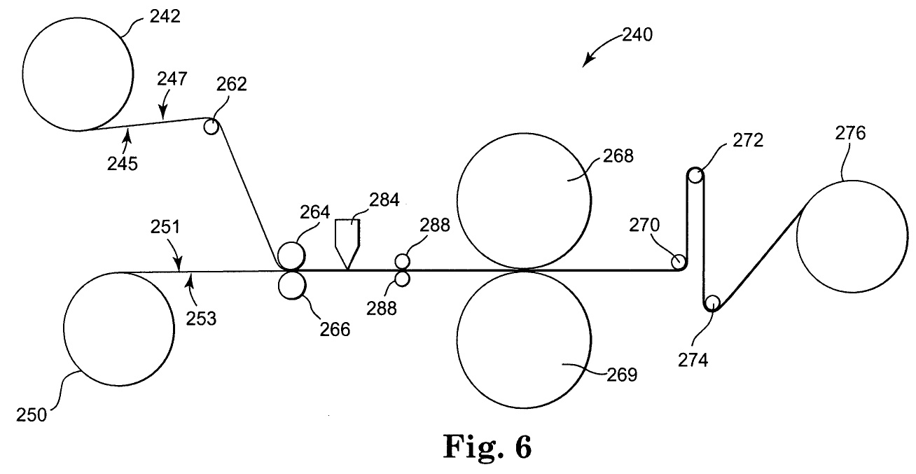

FIG. 6 is an alternative exemplary schematic of a process for carrying out the present invention. In process 240 as shown, first porous fabric 242 is provided having first major surface 245 and second major surface 247. A second porous fabric 250 is provided, having first major surface 251 and second major surface 253. The fabrics are guided by guides 262 (such as rollers or slide bars) as desired to position the fabrics in contact with each other at nip rollers 264 and 266. First porous fabric 242 is kept in close physical proximity, and preferably in direct physical contact, with second porous fabric 250 until plastisol is applied to the second major surface 247 of the first porous fabric 242 at plastisol delivery station 284. Proximity may be maintained by physical containment or optionally by precoating one or both surfaces of the fabrics with a light adhesive.

Plastisol is applied to the second major surface 247 of first porous fabric 242 by any appropriate technique, such as described above, in an amount effective to at least partially pass through first porous fabric 242 and contact second porous fabric 250. Optionally, an operation subsequent to application of the plastisol to first porous fabric 242 may be carried out at plastisol modulation station 288 to remove excess amounts of plastisol. Such operations may be carried out as described above. Such plastisol removal operations may additionally serve to press first porous fabric 242 together with second porous fabric 250 to facilitate subsequent bonding of the fabrics.

The laminate of first porous fabric 242 to second porous fabric 250 is then passed through curing drums 268 and 269, whereby the plastisol is fused to a level sufficient to form a bond between first porous fabric 242 and second porous fabric 250. The fused laminate is then guided by such guide rollers or slide bars 270, 272 and 274 as desired to direct the laminate to take-up roll 276.

After manufacture of the composite as described above by any technique, the exposed face of the breathable wallcovering is preferably printed with a suitable ink to form desirable decorative patterns and designs. Such inks are well known and can be applied by various methods of printing such as by Gravure, flexography, screen printing, jet printing, web printing, etc. The printing operation may be repeated many times, as needed, to vary the colors and designs.

A particular advantage in one embodiment of the present invention is that the printed designs or patterns can be sharply defined, i.e., can have relatively smooth, even edges, when the plastisol presents a macroscopically continuous, smooth appearance on the second major surface of the first porous fabric sheet. Additionally, the composite wallcovering of the invention having plastisol that presents a macroscopically continuous, smooth appearance on the second major surface of the first porous fabric sheet, whether printed or not, can be embossed to provide an aesthetically pleasing texture such as a simulated leather grain.

The composite as described herein has been generically described as a wallcovering, in a non-limiting sense. It will be understood that the breathable wallcovering of the invention is preferably applied to a wall, but alternatively may be applied to any other substrate such as a floor, ceiling, container surface or other such substrate to provide an aesthetically pleasing, decorative covering, or a protective covering having a high moisture vapor permeability. Such a covering is particularly useful and advantageous for decorating walls in highly humid geographic areas.

The breathable wallcovering of the present invention may easily be applied to a substrate using an adhesive. Preferably, the adhesive is a water-based adhesive to facilitate moisture passage through the adhesive from the substrate to the wallcovering. For purposes of the present invention, an adhesive is considered to be water-based if, in a non-emulsion system, the adhesive contains water in an amount sufficient to act a solvent for the non-water adhesive components. An adhesive is considered to be water-based in an emulsion system if there is sufficient water present to act as one of the phases in an emulsion system. In adhesives wherein water is acting as a solvent, preferably, water is present as the majority component of the adhesive composition. In emulsion adhesive systems, preferably water is the continuous phase of the emulsion. Most preferably, the adhesive comprises hydrophilic components to facilitate moisture passage through the adhesive from the substrate to the wallcovering. Examples of such adhesives include PRO-880 or PRO-732 adhesives, commercially available from Roman Decorating Products, Calumet City, Ill.

Surprisingly, the wallcovering of the present invention may enhance the moisture transfer properties of the substrate as compared to a like substrate without the present invention. More specifically, certain substrates such as wallboard inherently have a limitation on the moisture transfer properties of the substrate due to their physical configuration and material constitution. Surprisingly, it has been found that applying a wallcovering as described herein can enhance the moisture transfer properties of that substrate to actually be higher than the moisture transfer properties of that substrate alone. While not being bound by theory, it is believed that the wallcovering construction as described herein acts as a radiator to increase the effective surface area of the substrate surface, virtually wicking out moisture from the substrate and improving moisture transfer therethrough.

The configuration of the present wallcovering has further been found to exhibit a configuration that tends to limit the flow of adhesives used to adhere the wallcovering to the substrate out from the second surface of the second fabric through the composite to second major surface of the first fabric. Thus, wallcovering of the present invention preferably is easily applied to a substrate without “bleed through” or “show through” of the underlying adhesive that adheres the wallcovering to the substrate.

### EXAMPLES

Perms are calculated in accordance with ASTM Standard Test Method E96, which describes the determination of water vapor transmission of materials through which the passage of water vapor may be of importance. Two methods are provided in ASTM E96: the Desiccant Method and the Water Method. Unless otherwise indicated, both of these methods evaluate the permeability of the sample as a free film (i.e. not adhered to a substrate) and are evaluated at a temperature of 23° C. with a dish having a mouth area of 2½ inches. In the Desiccant Method, the test specimen is sealed to the open mouth of a test dish containing a desiccant, and the assembly placed in a controlled atmosphere. Periodic weighings determine the rate of water vapor movement through the specimen into the desiccant. In the Water Method, the dish contains distilled water and the weighings determine the rate of vapor movement through the specimen from the water to the controlled atmosphere. For purposes of the present invention, perm values are reported in inch-pound units. One perm represents passage of one grain of water per square foot of material per hour under a pressure of one inch of mercury (1 perm=1 grain/(ft²·h·in Hg).

2.4 oz per sq. yd. 100% polyester fabric with a thread count of 32×26 has a colored PVC plastisol applied to the surface using a gravure cylinder as applicator roll. A second fabric 2.2 oz. per sq. yd. in weight consisting of 80/20 polyester/cotton with a thread count of 32×22 is placed against the first fabric. Sufficient plastisol wicks through the first fabric to act as an adhesive to hold the second fabric firmly attached to the first fabric. The two fabrics travel together around a metal curing drum, which has sufficient heat to fuse the plastisol. The initial plastisol surface is embossed with a smooth surface to insure printability at a later printing station.

All patents, patent documents, and publications cited herein are incorporated by reference as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A breathable wallcovering comprising:
a) a first porous fabric sheet having a first major surface and a second major surface; and
b) a second porous fabric sheet having a first major surface and a second major surface;
wherein the first major surface of the first porous fabric sheet is bonded to the first major surface of the second porous fabric sheet by an adhesively effective amount of a fused plastisol;
wherein the wallcovering has a moisture permeability of at least about 25 perms as measured by the Water Method.

2. The breathable wallcovering of claim 1, wherein the first porous fabric sheet is a woven fabric.

3. The breathable wallcovering of claim 2, wherein the first porous fabric sheet has a thread count of from 30×20 to about 40×40 and is made of fibers of about 200 to about 400 denier.

4. The breathable wallcovering of claim 2, wherein the first porous fabric sheet has a thread count of from 32×22 to about 36×36 and is made of fibers of about 200 to about 400 denier.

5. The breathable wallcovering of claim 2, wherein the second porous fabric sheet is a woven fabric.

6. The breathable wallcovering of claim 5, wherein the second porous fabric sheet has a thread count of from 30×20 to about 40×40 and is made of fibers of about 200 to about 400 denier.

7. The breathable wallcovering of claim 5, wherein the second porous fabric sheet has a thread count of from 32×22 to about 36×36 and is made of fibers of about 200 to about 400 denier.

8. The breathable wallcovering of claim 5, wherein the first and second porous fabric sheets have thread counts that are different from each other.

9. The breathable wallcovering of claim 1, wherein the first porous fabric sheet is a nonwoven fabric.

10. The breathable wallcovering of claim 1, wherein the first and second porous fabric sheets are both nonwoven fabrics.

11. The breathable wallcovering of claim 9, wherein the first porous fabric sheet comprises gaps between fibers of the fabric that are greater than that of a woven fabric having a thread count of 30×20 made from 300 denier fibers.

12. The breathable wallcovering of claim 9, wherein the first porous fabric sheet comprises gaps between fibers of the fabric that are greater than that of a woven fabric having a thread count of 36×36 made from 300 denier fibers.

13. The breathable wallcovering of claim 10, wherein each of the first and second porous fabric sheet comprise gaps between fibers of the fabric that are greater than that of a woven fabric having a thread count of 30×20 made from 300 denier fibers.

14. The breathable wallcovering of claim 1, wherein the plastisol is present at a coating weight of from about 0.33 lbs/yd² to about 0.66 lbs/yd².

15. The breathable wallcovering of claim 1, wherein the plastisol is a thermoplastic resin selected from the group consisting of polyacrylates, polyvinyl acetate, polyamides, acrylic copolymers, polyvinyl chloride, and mixtures thereof.

16. The breathable wallcovering of claim 1, wherein the wallcovering has a moisture permeability of at least about 40 perms.

17. The breathable wallcovering of claim 1, wherein the wallcovering has a moisture permeability of at least about 60 perms.

18. A method for manufacturing a breathable wallcovering, comprising:
a) providing a first porous fabric sheet having a first major surface and a second major surface;
b) providing a second porous fabric sheet having a first major surface and a second major surface;
a) applying a plastisol to at least one of the major surfaces of the first porous fabric sheet;
b) laminating the first major surface of the first porous fabric sheet to the first major surface of the second porous fabric sheet; and
c) fusing the plastisol to a level sufficient to form a bond between the first porous fabric sheet and the second porous fabric sheet;
wherein the wallcovering has a moisture permeability of at least about 25 perms.

19. The method of claim 18, wherein the plastisol is applied to the second major surface of the first porous fabric sheet.

20. The method of claim 18, wherein the plastisol is applied to the first major surface of the first porous fabric sheet.

21. The method of claim 18, wherein the plastisol is applied to both the first and second major surfaces of the first porous fabric sheet.

22. A method for manufacturing a breathable wallcovering, comprising:
a) providing a first porous fabric sheet having a first major surface and a second major surface;
b) providing a second porous fabric sheet having a first major surface and a second major surface;
c) positioning the first porous fabric sheet and the second porous fabric sheet so that the first major surface of the first porous fabric sheet is in close physical proximity with the first major surface of the second porous fabric sheet; and
d) applying an adhesively effective amount of a plastisol to the second major surface of the first porous fabric sheet, whereby sufficient amounts of plastisol composition penetrates the first porous fabric sheet to form a bond between the first porous fabric sheet and the second porous fabric sheet in the ultimate product; and
e) fusing the plastisol to a level sufficient to form a bond between the first porous fabric sheet and the second porous fabric sheet;
wherein the wallcovering has a moisture permeability of at least about 25 perms.

23. A method of providing a surface having high moisture transfer properties, comprising adhering a wallcovering of claim 1 to a surface.

24. The method of claim 23, wherein the wallcovering is adhered to the surface by a water-based adhesive.

25. A method of enhancing the moisture transfer properties of a substrate, comprising adhering a wallcovering of claim 1 to a surface of the substrate.
